(19) United States
(12) Patent Application Publication
(10) Pub. No.: US 2007/0015513 A1
(43) Pub. Date: Jan. 18, 2007

(54) Method and apparatus to facilitate forward channel gain adjustment with respect to soft handoff

(76) Inventors: Dean E. Thorson, Grayslake, IL (US); Kazuhiro Ondo, Buffalo Grove, IL (US); Eric Y. Tsou, Chicago, IL (US)

Correspondence Address: MOTOROLA, INC., 1303 EAST ALGONQUIN ROAD, IL01/3RD, SCHAUMBURG, IL, 60196, US

(21) Appl. No.: 11/179,317

(22) Filed: Jul. 12, 2005

(51) Int. Cl. H04Q 7/20

(52) U.S. Cl. 455/442; 455/436

(57) ABSTRACT

Upon detecting (101) at least a potential soft handoff of a mobile station, wherein the soft handoff would entail a net reduction in allocated system resources for that mobile station, one automatically facilitates adjustment (103) of the forward channel gain for at least one base station as is presently supporting that mobile station prior to actually effecting the net reduction in allocated system resources.

### TECHNICAL FIELD

This invention relates generally to soft handoff in wireless communication systems and more particularly to the adjustment of base station forward channel gain.

### BACKGROUND

Many wireless communication systems offer a plurality of potential edge element points of attachment. So architected, as a mobile station moves from place to place the point (or points) of attachment as couple that mobile station to the communication system can and will vary. To facilitate such mobility many communication systems facilitate some form of handoff (also sometimes referred to as “handover”). A so-called soft handoff typically occurs when a new point of attachment becomes established prior to breaking an existing point of attachment.

Some systems, such as some code division multiple access (CDMA) communication systems, permit a mobile station to be simultaneously attached to multiple points of attachment (i.e., base stations). It therefore becomes possible that a soft handoff will result in a net increase or decrease in the quantity of system resources that are presently allocated to support a given mobile station. For example, when a mobile station presently has three points of attachment, a soft handoff may result in a same number of allocated resources, an increased number of channel resources (such as, for example, four points of attachment), or a decreased number of channel resources (such as, for example, two points of attachment) being allocated to support that mobile station.

When a soft handoff yields a reduced number of allocated resources for a given mobile station, quality of service may drop as well. To ameliorate such a result, it is known to automatically adjust forward channel gain for one or more of the remaining base stations as comprise the resultant points of attachment. This adjustment occurs following completion of the soft handover. Unfortunately, this approach does not always fully yield the desired maintenance (or improvement) of quality of service. Instead, it is possible for delivered quality of service to momentarily degrade following a handoff pending adjustment of this forward channel gain.

### BRIEF DESCRIPTION OF THE DRAWINGS

The above needs are at least partially met through provision of the method and apparatus to facilitate forward channel gain adjustment with respect to soft handoff described in the following detailed description, particularly when studied in conjunction the drawings, wherein:

FIG. 1 comprises a flow diagram as configured in accordance with various embodiments of the invention; and

FIG. 2 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the arts will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, upon detecting at least a potential soft handoff of a mobile station, wherein the soft handoff would entail a net reduction in allocated system resources for that mobile station, one automatically facilitates adjustment of the forward channel gain for at least one base station as is presently supporting that mobile station prior to actually effecting the net reduction in allocated system resources.

Detecting the potential for a soft handoff can comprise, for example, receiving a message from the mobile station which message indicates a need to drop at least one presently allocated system resource from an active set of system resources as are presently allocated to support the mobile station. In a preferred embodiment the aforementioned adjustment of the forward channel gain comprises calculating an appropriate increased forward channel gain based, at least in part, upon a reduced active set of system resources as are allocated to support the mobile station.

So configured, a mobile station is more likely to be assured of adequate quality of service during and following a soft handoff. In many cases the quality of service can be maintained or even improved rather than temporarily diminished. These teachings can be implemented without requiring modification of the mobile stations in at least many communication systems, thereby easing use and facilitation of these embodiments.

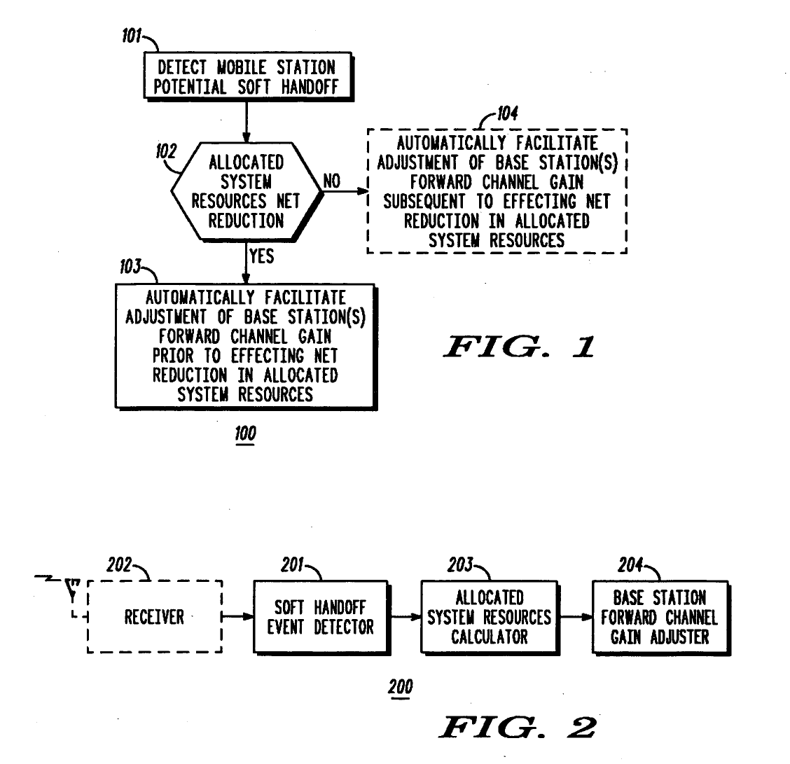

These and other benefits may become clearer upon making a thorough review and study of the following detailed description. Referring now to the drawings, and in particular to FIG. 1, an exemplary process 100 that accords with these teachings provides for detecting 101 at least a potential soft handoff of a mobile station. The detection mechanism and/or trigger can and will vary with the specifics of a given system, of course, as will be well understood by those skilled in the art.

As one example, this step of detecting at least a potential soft handoff can comprise receiving, from a mobile station, a message (such as, but not limited to, a pilot strength measurement message which indicates that a pilot (and hence a corresponding point of attachment) should be dropped from a presently active set as presently characterizes certain code division multiple access (CDMA) communication systems) that indicates a need to drop at least one presently allocated system resource from an active set of system resources (such as, for example, allocated base site attachments) as are presently allocated to support that mobile station.

This process 100 then preferably provides for determining 102 whether dropping the at least one presently allocated system resource will result in a net reduction of total system resources as are presently allocated to support the mobile station. When true, meaning that the net quantity of allocated system resources will be reduced upon effecting the corresponding soft handoff, this process 100 then preferably provides for automatically facilitating adjustment 103 of a forward channel gain for at least one base station as presently supports the mobile station prior to actually effecting that net reduction in allocated system resources (i.e., prior to effecting, in this case, the soft handoff). In a preferred embodiment this may comprise adjusting the forward channel gain as a function, at least in part, of a calculation for an appropriate increased forward channel gain that is itself based, at least in part, upon consideration of a reduced active set of such system resources as are, and as will be subsequent to effecting the soft handoff, allocated to support the mobile station.

The specifics of any such calculation will of course again vary from system to system and may also vary with respect to the needs and/or perceived requirements of a given system administrator. For example, this calculation can be weighted to tend to derive a forward channel gain that will at least maintain a present quality of service level. As another example, this calculation may be weighted to tend to derive a forward channel gain that at least attempts to match a quality of service goal regardless of any presently achieved quality of service level (meaning, for example, that the new resultant quality of service level may be considerably higher or lower post-soft handoff depending upon the relative variance between the quality of service goal and the previously attained quality of service level).

Those skilled in the art will further appreciate and understand that this step of adjusting a forward channel gain can comprise, when and as appropriate or desired, adjustment of the forward channel gain for each of a plurality of presently allocated system resources. For example, in a situation where a given mobile station is presently supported by five base stations, and is about to effect a soft handoff following which the mobile station will only be supported by four base stations (where one of the four will comprise a new base station that is not a part of the original five), it may be useful to apply these teachings in a way that results in an increase to the forward channel gain for each of three of the base stations as are presently supporting the mobile station and which will continue to support the mobile station subsequent to the soft handoff.

There will also likely be times when the step of determining 102 whether a reduction in allocated system resources occurs will conclude that no such reduction occurs. Instead, for example, the net number of allocated resources may remain the same or may even increase. In such a case, the process 100 can take such action in this regard as may be desired. As one suggestion, and as shown as an optional response in FIG. 1, this process 100 can provide in such a case for automatically adjusting 104 a forward channel gain for at least one base station as then presently supports the mobile station subsequent to actually effecting the soft handoff. This, of course, tends to mirror prior art practice in this regard which may well prove adequate under such circumstances.

So configured, these teachings permit forward channel gain values for one or more base stations to be dynamically increased prior to effecting the conclusion of a soft handoff in order to compensate for (or to at least ameliorate the impact of) a soft handoff that will, once completed, result in a net reduction in points of attachment for a given mobile station. More particularly, by increasing the forward channel gain values of such base stations in a code division multiple access communication system, the corresponding power and hence the corresponding effective bandwidth and quality of service will be increased as well. Properly calculated, this increase can equal (or even exceed, if desired) a present level of service that effectively compensates for the channel resource loss when it occurs. This in turn will assist with maintaining link reliability and maintenance of a correct soft handoff state in the mobile station which will aid in maintaining call session continuity and viability.

Those skilled in the art will appreciate that these benefits are attainable without need for modification of presently designed and/or fielded mobile stations. It will also be understood and appreciated that these teachings are readily deployable via, for example, programming changes with respect to legacy infrastructure equipment if desired.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

Pursuant to an optional but preferred approach, these teachings are implemented via an apparatus 200 such as a base station as comprises a part of a code division multiple access communication system (and more typically, a base station as actually presently supports the mobile station in question). This apparatus 200 can comprise a soft handoff event detector 201 that operably couples to an allocated system resources calculator 203 which in turn drives a base station forward channel gain adjuster 204.

More particularly, the soft handoff event detector 201 may preferably be configured and arranged to detect when at least a potential soft handoff of a mobile station may occur. Pursuant to one approach, this can comprise detecting receipt of a message from that mobile station via a corresponding receiver 202, which message indicates a need to drop at least one presently allocated system resource from an active set of system resources as are presently allocated to support the mobile station.

The allocated system resources calculator 203, in turn, is preferably responsive to the soft handoff event detector 201 and is further configured and arranged to determine when a soft handoff would entail a net reduction in allocated system resources for that mobile station. This can comprise, for example, a calculation to determine a quantitative difference between a present number of allocated base site attachments and a post-soft handoff number of allocated base site attachments. This conclusion by the allocated system resources calculator 203 can then further inform the operations of the base station forward channel gain adjuster 204.

In particular, the base station forward channel gain adjuster 204 is preferably configured and arranged to automatically adjust, prior to actually effecting a soft handoff, forward channel gain for at least one base station as has been allocated to support the mobile station when a net allocation is going to be reduced. Calculations regarding forward channel gain are already known in the art and may be employed in this setting if desired. Those skilled in the art will understand and appreciate, however, that pursuant to these teachings, when a net reduction in total system resources as allocated is about to occur, such calculations will preferably be carried out as though the net reduction had already occurred. This, of course, contrasts sharply with present practice in this regard.

The above-described platform and/or steps can be carried out in a distributed fashion or can be more centralized to best accommodate and/or leverage the limitations and/or capabilities of a given system. For example, each base station can make an independent detection and/or calculation and adjustment for itself. Or, if desired, such calculations and adjustment can be performed by a master base station or other server on behalf of a group of base stations. Other possibilities exist as well as will be recognized by those skilled in the art.

So configured and arranged, it can be seen that these teachings provide for a mechanism to facilitate detecting at least a potential soft handoff of a mobile station wherein the soft handoff would entail a net reduction in allocated system resources for the mobile station. These teachings then provide for a corresponding response by automatically facilitating, prior to actually effecting the net reduction in allocated system resources for the mobile station, adjustment of a forward channel gain for at least one base station as presently supports that mobile station.

As noted above, detection of a potential soft handoff event can comprise, in at least some application settings, receiving, from the mobile station, a message indicating a need to drop at least one presently allocated system resource from an active set of system resources as are presently allocated to support the mobile station. Those skilled in the art will further appreciate that these teachings can be compatibly deployed, if desired, with existing soft handoff practices in that the present technique of automatically adjusting forward channel gains subsequent to actually effecting a soft handoff can be continued in instances where the soft handoff will not entail a net reduction in allocated system resources for the mobile station.

So configured, quality of service levels are more likely to equal or exceed those levels as are presently achieved during soft handoff events. As these teachings are readily deployable without requiring modification of the mobile stations themselves, these benefits are attainable at reasonable cost and without undue administrative effort or time being required.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
detecting at least a potential soft handoff of a mobile station wherein the soft handoff would entail a net reduction in allocated system resources for the mobile station;
prior to actually effecting the net reduction in allocated system resources for the mobile station, automatically facilitating adjustment of a forward channel gain for at least one base station as presently supports the mobile station.

2. The method of claim 1 wherein detecting at least a potential soft handoff of a mobile station comprises:
receiving, from the mobile station, a message indicating a need to drop at least one presently allocated system resource from an active set of system resources as are presently allocated to support the mobile station;
determining whether dropping the at least one presently allocated system resource will result in a net reduction of total system resources as are allocated to support the mobile station.

3. The method of claim 1 wherein the allocated system resources comprise allocated base site attachments.

4. The method of claim 1 wherein automatically facilitating adjustment of a forward channel gain for at least one base station further comprises:
calculating an appropriate increased forward channel gain.

5. The method of claim 4 wherein calculating an appropriate increased forward channel gain further comprises calculating an appropriate increased forward channel gain based, at least in part, upon a reduced active set of the system resources as are allocated to support the mobile station.

6. The method of claim 1 further comprising:
detecting at least a potential soft handoff of a mobile station wherein the soft handoff would not entail a net reduction in allocated system resources for the mobile station;
subsequent to actually effecting the soft handoff, automatically adjusting a forward channel gain for at least one base station as then presently supports the mobile station.

7. An apparatus comprising:
a soft handoff event detector;
an allocated system resources calculator responsive to the soft handoff detector and being configured and arranged to determine when a soft handoff would entail a net reduction in allocated system resources for a mobile station;
a base station forward channel gain adjuster responsive to the allocated systems resources calculator and being configured and arranged to automatically adjust, prior to actually effecting the soft handoff, forward channel gain for at least one base station as has been allocated to support the mobile station.

8. The apparatus of claim 7 wherein the apparatus comprises a base station.

9. The apparatus of claim 8 wherein the base station comprises a base station that presently supports the mobile station.

10. The apparatus of claim 7 further comprising:
a receiver that operably couples to the soft handoff event detector wherein the receiver is configured and arranged to receive a message from the mobile station indicating a need to drop at least one presently allocated system resource from an active set of system resources as are presently allocated to support the mobile station.

11. The apparatus of claim 10 wherein the allocated system resources calculator comprises means for determining whether dropping the at least one presently allocated system resource will result in a net reduction of total system resources as are allocated to support the mobile station.

12. The apparatus of claim 7 wherein the allocated system resources comprise base site attachments.

13. The apparatus of claim 7 wherein the base station forward channel gain adjuster comprises means for calculating an appropriate increased forward channel gain for the at least one base station as has been allocated to support the mobile station.

14. The apparatus of claim 13 wherein the means for calculating an appropriate increased forward channel gain for the at least one base station as has been allocated to support the mobile station further comprises means for calculating an appropriate increased forward channel gain based, at least in part, upon a reduced active set of the system resources as are allocated to support the mobile station.

15. An apparatus comprising:
means for detecting at least a potential soft handoff of a mobile station wherein the soft handoff would entail a net reduction in allocated system resources for the mobile station;
means responsive to the means for detecting for automatically facilitating, prior to actually effecting the net reduction in allocated system resources for the mobile station, adjustment of a forward channel gain for at least one base station as presently supports the mobile station.

16. The apparatus of claim 15 wherein the means for detecting further comprises:
means for receiving, from the mobile station, a message indicating a need to drop at least one presently allocated system resource from an active set of system resources as are presently allocated to support the mobile station;
means responsive to the means for receiving for determining whether dropping the at least one presently allocated system resource will result in a net reduction of total system resources as are allocated to support the mobile station.

17. The apparatus of claim 15 wherein the allocated system resources comprise allocated base site attachments.

18. The apparatus of claim 15 wherein the means for automatically facilitating adjustment of a forward channel gain for at least one base station further comprises:
means for calculating an appropriate increased forward channel gain.

19. The apparatus of claim 18 wherein the means for calculating an appropriate increased forward channel gain further comprises means for calculating an appropriate increased forward channel gain based, at least in part, upon a reduced active set of the system resources as are allocated to support the mobile station.

20. The apparatus of claim 15 wherein the means for detecting further comprises means for detecting at least a potential soft handoff of a mobile station wherein the soft handoff would not entail a net reduction in allocated system resources for the mobile station, and further comprising:
means responsive to the means for detecting at least a potential soft handoff of a mobile station wherein the soft handoff would not entail a net reduction in allocated system resources for the mobile station for automatically adjusting, subsequent to actually effecting the soft handoff, a forward channel gain for at least one base station as then presently supports the mobile station.
